(19) United States
(12) Patent Application Publication
(10) Pub. No.: US 2025/0380189 A1
(43) Pub. Date: Dec. 11, 2025

(54) DATA SAVING PROFILES FOR VISITED NETWORKS

(71) Applicant: T-Mobile USA, Inc., Bellevue, WA (US)

(72) Inventor: Christopher Bailey, Overland Park, KS (US)

(21) Appl. No.: 18/740,322

(22) Filed: Jun. 11, 2024

(51) Int. Cl. H04W 28/06; H04W 4/14; H04W 84/04

(52) U.S. Cl. CPC H04W 28/06; H04W 4/14; H04W 84/042

(57) ABSTRACT

Described herein is a user equipment (UE) configured to determine an occurrence of a triggering event associated with a data saving profile and, in response, activate the data saving profile. The data saving profile includes rules for at least two of stopping background data, limiting short message service (SMS) retries, early timeouts, stopping incoming calls or redirecting incoming calls to voicemail, blocking video streaming, limiting connection attempts, restricting use of the UE as a personal hotspot, or restricting use of certain access point names (APNs) or data network names (DNNs). The UE then applies the rules of the data saving profile to at least one of incoming data or outgoing data. The applying of the rules limits some data transmissions without stopping all data transmissions.

### BACKGROUND

When connecting to visited telecommunication networks, a user equipment (UE) often experiences a different level of performance and is subject to different charges than when it is using its home telecommunications network. This can be true when connecting to roaming partners or other networks. Rules for data transmission on the UE are typically configured for behavior on the home telecommunication network, with behaviors such as background data transmission, short message service (SMS) retries, etc., all optimized for the performance and charges expected for the UE when on its home telecommunication network. The only options presented on some UEs to change this behavior is to stop all data transmissions, not connect to cellular networks, not connect to WiFi networks, etc. The result for a UE with a user that wishes to have network connectivity and some data transmissions while outside the home telecommunications network can be a poor user experience (slow loading, timeouts, etc.), additional charges, or both.

### BRIEF DESCRIPTION OF THE DRAWINGS

The detailed description is set forth with reference to the accompanying figures. In the figures, the left-most digit(s) of a reference number identifies the figure in which the reference number first appears. The same reference numbers in different figures indicate similar or identical items.

FIG. 1 shows a UE at different locations connecting to home and visited telecommunication networks and experiencing different metrics for data transmissions when outside of the UE's home telecommunications network.

FIG. 2 illustrates a UE with a data saving profile that, when activated, applies rules that limit some data transmissions without stopping all data transmissions and shows results of the UE applying the data saving profile in visited telecommunication networks.

FIG. 3 is a flow diagram of an illustrative process for determining, by a UE, an occurrence of a triggering event for a data saving profile, activating that data saving profile, and applying rules of the data saving profile to at least one of inbound or outbound data transmissions.

FIG. 4 is a schematic diagram of a computing device capable of implementing functionality of a UE.

### DETAILED DESCRIPTION

This disclosure is directed in part to a user equipment (UE) configured to determine an occurrence of a triggering event associated with a data saving profile and, in response, activate the data saving profile. The UE then applies rules of the data saving profile to at least one of incoming data or outgoing data. The applying of the rules limits some data transmissions without stopping all data transmissions.

As used herein, “data saving profile” refers to a set of rules defined in, e.g., an extensible markup language (XML) document or similar data structure that allow some data transmissions and limit others. The “data saving profile” does not stop all data transmissions. Further, the rules of the “data saving profile” include rules for at least two of stopping background data, limiting short message service (SMS) retries, early timeouts, stopping incoming calls or redirecting incoming calls to voicemail, blocking video streaming, limiting connection attempts, restricting use of the UE as a personal hotspot, or restricting use of certain access point names (APNs) or data network names (DNNs).

In various implementations, the data saving profile may be pre-installed at the time of UE manufacture or initial configuration upon first provisioning from a provider of the home telecommunications network. Such installing is referred to as “pre-installing” as it occurs before a use of the UE by its user. The data saving profile may also be received as it is used. For example, a data saving profile may be first received upon connecting to a PLMN and, in such an example, may even be optimized for that PLMN.

As noted herein, the UE may, in some implementations, receive multiple data saving profiles from one or more sources (e.g., different data saving profiles from different PLMNs, etc.). In such implementations, the multiple data saving profiles may each have its own triggering events or they may share triggering events. When one has its own triggering events, the occurrence of one of those events effectively selects that data saving profile. When triggering events apply to multiple data saving profiles, other criteria may determine which data saving profile is selected. For instance, the UE may determine a current PLMN and select a data saving profile for that PLMN. Alternatively, the user may be in the midst of a workday, resulting in the UE operating in a “business” user activity profile being activated and applied. In such circumstances, the data saving profile for that user activity profile may be selected by the UE.

In various implementations, triggering events for the UE may include any of receiving an instruction to activate the data saving profile from a server, base station, or access point; connecting to a new/different PLMN; roaming; moving across a geofence boundary; or connecting to a specific APN or DNN. The triggering events may be defined by a configuration of the UE, specified by the data saving profile(s), or a combination of such mechanisms.

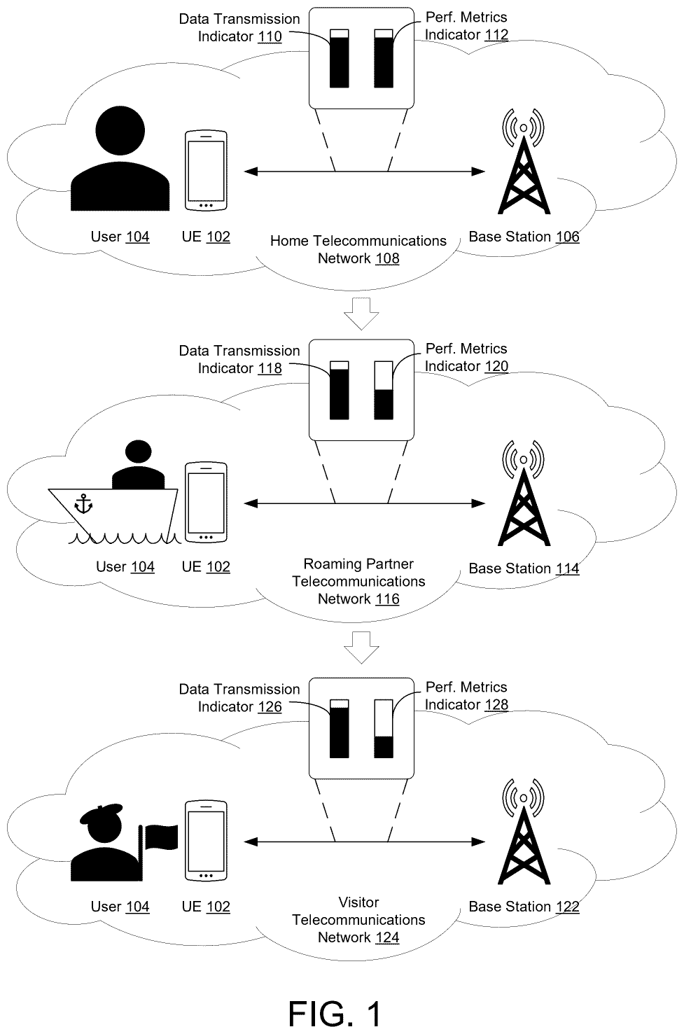

FIG. 1 shows a UE at different locations connecting to home and visited telecommunication networks and experiencing different metrics for data transmissions when outside of the UE's home telecommunications network. As illustrated, a UE 102 of a user 104 may be connected to a base station 106 within a home telecommunications network 108. Indicator 110 shows an amount of data transmitted between the UE 102 and home telecommunications network 108, and indicator 112 shows a performance measurement for those data transmissions. The UE 102 can also connect to a base station 114 of a roaming partner telecommunications network 116. Indicator 118 shows a same amount of data (or higher) being transmitted between the UE 102 and roaming partner telecommunications network 116 as between the UE 102 and home telecommunications network 108, an indicator 120 shows a worse performance measurement for the data transmissions to the roaming partner telecommunications network 116 than indicator 112 shows for data transmissions to the home telecommunications network. Further, the UE 102 can be connected to a base station 122 of another visited telecommunications network 124. Indicator 126 shows a same amount of data (or higher) being transmitted between the UE 102 and visited telecommunications network 124 as between the UE 102 and home telecommunications network 108, an indicator 128 shows a worse performance measurement for the data transmissions to the visited telecommunications network 124 than indicator 112 shows for data transmissions to the home telecommunications network.

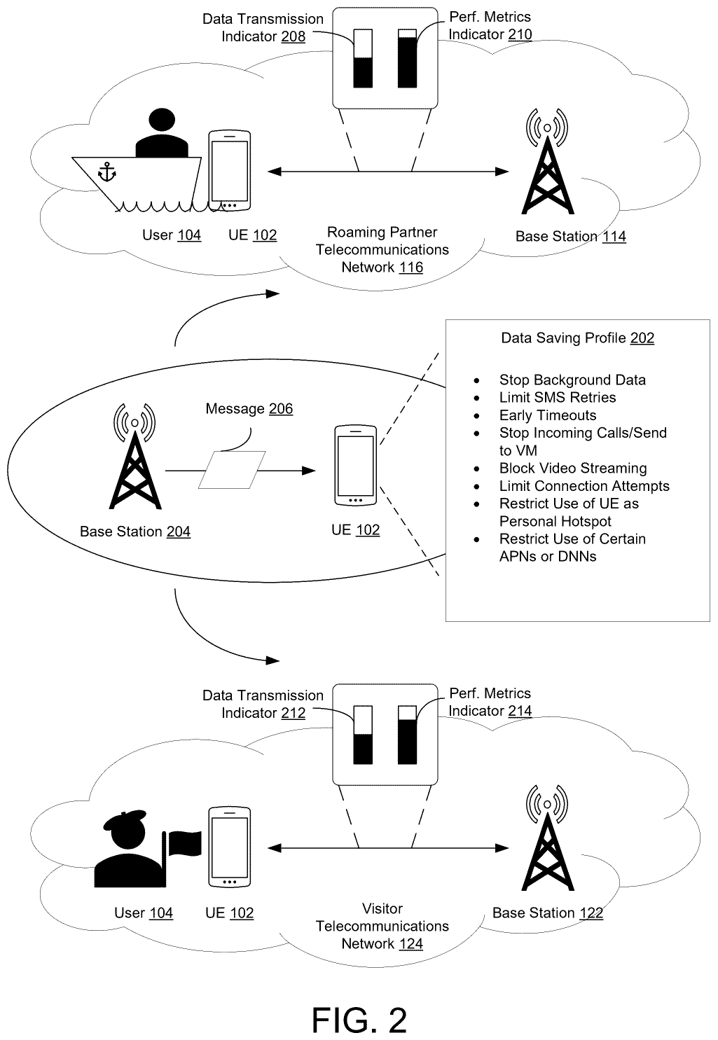

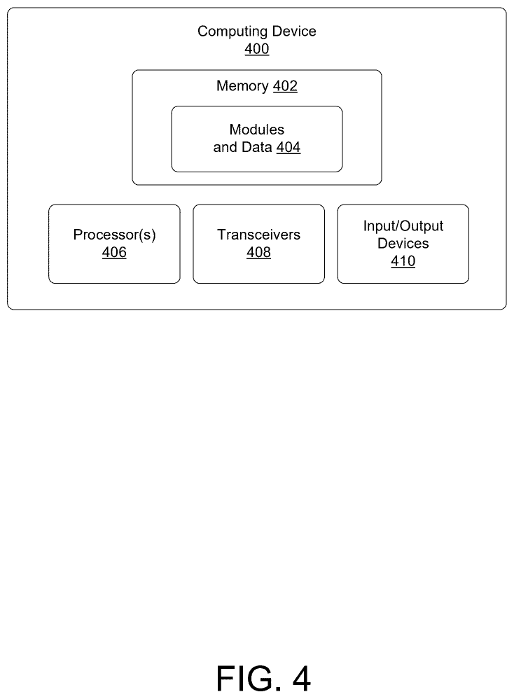

In various implementations, the UE 102 may be any sort of mobile telecommunications device. UE 102 may be a cellular phone, a tablet computer, a watch, goggles, an Internet-of-Things (IoT) device, a personal computer (PC), a gaming device, or any sort of device capable of wireless and/or cellular communication with telecommunications network. UE 102 may be a device of a user 104 who subscribes for telecommunication services with a telecommunication service provider. The telecommunication service provider or an affiliated entity may operate a telecommunications network that serves as a home telecommunications network 108 of the UE 102. The UE 102 is also described in greater detail herein with respect to FIGS. 2 and 4.

The base stations 106, 114, and 122 may each be any kind of cellular base station, wireless access point, satellite, or other mechanism providing cellular and/or wireless communication capabilities. Any one or more of the base stations 106, 114, and 122 may operate in accordance with Third Generation Partnership Protocol (3GPP) standards and may implement sixth generation (6G) technology, fifth generation (5G) technology, fourth generation (4G) technology, third generation (3G) technology, or any earlier or later generation of technology. Further, the base stations 106, 114, and 122 may each include one or more radio antennas, wireless transceivers, etc. and may be capable of multiple-input-multiple-output (MIMO), beam-forming, etc. Different ones of the base stations 106, 114, and 122 may have different ones of these characteristics; for example, base station 106 may be a 5G base station, while base station 122, which may be located in a different country, may be a 3G base station.

In some implementations, telecommunications networks 108, 116, and 124 may each be any of 3G, 4G, 5G, 6G, WiFi, satellite, etc. networks, with the type of network varying with the capabilities of its corresponding base station 106, 114, or 122. The home telecommunication network 108 may be operated by a service provider that the user 104 subscribes to, or by an affiliate of such a provider. Such a home telecommunications network 108 may store more information about the user 104 and UE 102 than other telecommunications networks and may offer better service, as measured by service metrics such as speed, quality-of-service (QoS), etc. The telecommunications networks 116 and 124 are both visited telecommunication networks, with roaming partner telecommunications network 116 being a roaming partner of the operator of home telecommunications network 108. As a roaming partner it may offer better service, within limitations, than a visited telecommunication network that is not a roaming partner. Such limitations may allow for the better service but still more limited service than provided by a home telecommunications network 108.

Indicators 110, 118, and 126 each show an amount of data being transmitted, with the dark portion of the measurement bar indicating a relative amount of data. As can be seen in FIG. 1, a similar amount of data is being transmitted by the UE 102 in each of the home telecommunications network 108, the roaming partner telecommunications network 116 and the visited telecommunications network 124. No adjustments are made to data transmission behaviors such as background data transmissions, etc.

Indicators 112, 120, and 128 each show a collective representation of one or more measurements of data transmission performance (e.g., speed, QoS, etc.), with the dark portion of the measurement bar indicating a relative degree of good performance (with a larger dark portion indicating better performance). As shown in FIG. 1, performance measures represented by indicator 112 are better than those represented by indicators 120 and 128. Indicator 112 represents performance measures for the home telecommunications network 108, while indicators 120 and 128 represent performance measures for visited telecommunication networks (e.g., roaming partner telecommunications network 116 and/or visited telecommunications network 124).

These indicators may correspond to experiences of the user 104 at different locations. For example, the user 104 may be on a cruise and connect to the roaming partner telecommunications network 116. Because of the capabilities of the UE 102 on the roaming partner telecommunications network 116, the limitations of the roaming partner telecommunications network 116 for visiting UEs, etc., some data transmission experiences may be poor. Retries of SMS messages may not have the same results as if those messages were transmitted over the home telecommunications network 108, map data may download very slowly, to the point where a mapping application needed to navigate is unusable, etc. Also, if data transmissions exceed a limit, all data transmission may be stopped, or the user 104 may be charged an additional amount.

FIG. 2 illustrates a UE with a data saving profile that, when activated, applies rules that limit some data transmissions without stopping all data transmissions and shows results of the UE applying the data saving profile in visited telecommunication networks. As illustrated, a UE 102 of a user 104 equipped with a data saving profile 202. The UE 102 may be connected to a base station 204 that may provide a message 206 with the data saving profile 202 or with an instruction to activate the data saving profile 202. FIG. 2 also shows the effect of applying the data saving profile 202 on the data transmissions with the roaming partner telecommunications network 116 and on the data transmissions with the other visited telecommunications network 124. For example, indicator 208 shows less data being transmitted than indicator 118, while indicator 210 shows better performance measurements than indicator 120. Also, indicator 212 shows less data being transmitted than indicator 126, while indicator 214 shows better performance measurements than indicator 128.

In various implementations, the data saving profile 202 may be an XML document or other data structure or mechanism that at least specifies rule(s) limiting data transmission without stopping all data transmission. For example, the rule(s) may specify at least two of stopping background data, limiting SMS retries, early timeouts, stopping incoming calls or redirecting incoming calls to voicemail, blocking video streaming, limiting connection attempts, restricting use of the UE as a personal hotspot, or restricting use of certain APNs or DNNs. In some implementations, multiple ones of the rules of the data saving profile 202 may be expressed as a single requirement that limits or blocks data transmissions not resulting from an action initiated by user 104. These rules are given as examples; other types of rules limiting any other type of data transmission between UE 102 and a telecommunications network may also or instead be included in the data saving profile 202. Also, as mentioned, the data saving profile 202 may specify triggering events that, when they occur, will result in the UE 102 activating the data saving profile and applying its rules to data transmissions.

The base station 204 may be an example of any of base stations 106, 114, or 122. As illustrated, base station 204 may send a message 206 to the UE 102 that includes the data saving profile 202 and/or an instruction to activate a data saving profile 202 stored on the UE 102. Such a message 206 may be any one or more messages transmitted using any sort of protocol.

In addition to transmission from base station 204 or a previous base station, the data saving profile 202 may be pre-installed on the UE 102, as is describer herein. Further, multiple data saving profiles 202 may be sent to and received by UE 102—pre-installed, sent by base station 204 or another base station, or both. In such implementations, the multiple data saving profiles 202 may each have its own triggering events or they may share triggering events. When one has its own triggering events, the occurrence of one of those events effectively selects that data saving profile 202. When triggering events apply to multiple data saving profiles 202, other criteria may determine which data saving profile 202 is selected. For instance, the UE 102 may determine a current PLMN (e.g., the PLMN of base station 204) and select a data saving profile 202 for that PLMN. In another example, the user 104 may be in the midst of a workday, resulting in the UE 102 operating in a “business” user activity profile being activated and applied. In such circumstances, the data saving profile 202 for that user activity profile may be selected by the UE 102.

In various implementations, triggering events for the UE 102 may include any of receiving an instruction to activate the data saving profile 202 from a server, base station (e.g., base station 204), or access point; connecting to a new/different PLMN; roaming; moving across a geofence boundary; or connecting to a specific APN or DNN. The triggering events may be defined by a configuration of the UE 102, specified by the data saving profile(s) 202, or a combination of such mechanisms. In some implementations, the UE 102 receives the instruction or receiving the data saving profile 202 (e.g., in message 206) when the UE 102 A) connects to a network other than its home telecommunications network 108 and 2) is subject to a reduced data QoS or to a data limit.

In further implementations, FIG. 2 shows the effects of applying the data saving profile 202 to data transmissions between the UE 102 and the roaming partner telecommunications network 116. Indicator 208 shows less data being transmitted than indicator 118 shows in FIG. 1—some of the data transmitted in FIG. 1 may not be transmitted in FIG. 2 because of the data saving profile 202. Indicator 210 shows the performance metrics for the data transmissions using the data saving profile 202; the performance metrics are higher in FIG. 2, represented by indicator 210, than the performance metrics are in FIG. 1. Further, because the data saving profile 202 is selectively limiting types of data transmissions, those which are important to the user 104 may not be limited at all, whereas others may be stopped entirely.

FIG. 2 also shows the effects of applying the data saving profile 202 to data transmissions between the UE 102 and the other visitor telecommunications network 124. Indicator 212 shows less data being transmitted than indicator 126 shows in FIG. 1—some of the data transmitted in FIG. 1 may not be transmitted in FIG. 2 because of the data saving profile 202. Indicator 214 shows the performance metrics for the data transmissions using the data saving profile 202; the performance metrics are higher in FIG. 2, represented by indicator 214, than the performance metrics are in FIG. 1.

In some implementations, applying the data saving profile 202 may include requesting the user 104 to approve or reject a suggested blacklist of websites or services. Such websites or services may be known to transmit large amounts of data (e.g., such as data not consumed directly by the user 104).

Additionally, the UE 102, in applying the data saving profile 202, may enhance or request enhancement of speed or QoS for data transmissions not effected by the rules of the data saving profile 202. Such enhancement may further contribute to the improved performance measurements shown in indicators 210 and 214.

In various implementations, the UE 102 may also be configured to enable the user 104 to toggle the use of the data saving profile 202 on or off (e.g., through a settings user interface) or enable more granular control, toggling on or off individual rules of the data saving profile 202 or toggling on or off individual triggering events.

Further, in some implementations the UE 102 may implement machine learning techniques to update an optimize the data saving profile 202 for the user 104. Such machine learning techniques may involve noting services and features not used by the user 104 and creating rules to limit associated data transmissions or noting attempts to circumvent rules that prohibit certain data transmission.

Also or instead, the service provider for the UE 102 (e.g., the operator of the home telecommunications network 108) may implement machine learning techniques to update and optimize a data saving profile 202 for user 104 or for a group of users.

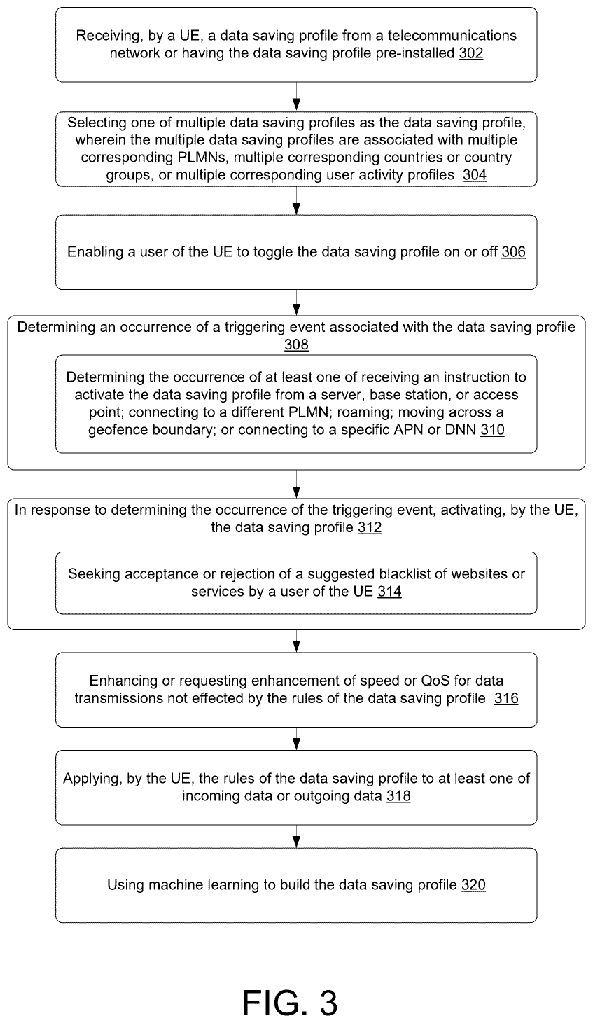

FIG. 3 illustrates an example process. This process is illustrated as logical flow graph, each operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be omitted or combined in any order and/or in parallel to implement the processes.

FIG. 3 is a flow diagram of an illustrative process for determining, by a UE, an occurrence of a triggering event for a data saving profile, activating that data saving profile, and applying rules of the data saving profile to at least one of inbound or outbound data transmissions. As illustrated at 302, a UE may have a data saving profile pre-installed on the UE (e.g., at the time of manufacture or initial provisioning when subscribing to the service provider for the home telecommunications network) or may receive the data saving profile when connecting to the home telecommunications network or to a visited telecommunications network. The data saving profile includes rules for at least two of stopping background data, limiting SMS retries, early timeouts, stopping incoming calls or redirecting incoming calls to voicemail, blocking video streaming, limiting connection attempts, restricting use of the UE as a personal hotspot, or restricting use of certain APNs or DNNs. In some implementations, multiple ones of the rules of the data saving profile may be expressed as a single requirement that limits or blocks data transmissions not resulting from an action initiated by a user of the UE (or, put differently, that only allows data transmissions that do result from an action initiated by the user).

At 304, the UE may select one of multiple data saving profiles as the data saving profile. The multiple data saving profiles may be associated with multiple corresponding PLMNs, multiple corresponding countries or country groups, or multiple corresponding user activity profiles (e.g., “home”, “business”, etc.) and may have been received over time, as the UE connects to different networks, or at once.

At 306, the UE may enable a user of the UE to toggle the data saving profile on or off. While shown between operations 304 and 308, such enabling may occur at any point after a data saving profile has been received or installed.

At 308, the UE determines an occurrence of a triggering event associated with the data saving profile (e.g., the selected data saving profile). The triggering event may be at least one of receiving an instruction to activate the data saving profile from a server, base station, or access point; connecting to a different PLMN; roaming; moving across a geofence boundary; or connecting to a specific APN or DNN. At 310, the determining comprises determining the occurrence of at least one of the receiving the instruction, connecting to the different PLMN, roaming, moving across the geofence boundary, or connecting to the specific APN or DNN. Further, in various implementations, the UE receives the instruction or receives the data saving profile when the UE A) connects to a network other than its home network and 2) is subject to a reduced data QoS or to a data limit.

At 312, in response to determining the occurrence of the triggering event, the UE activates the data saving profile. In some implementations, the data saving profile may include a suggested blacklist of websites or services, and at 314, the activating may comprise seeking acceptance or rejection of the suggested blacklist by a user of the UE.

At 316, the UE may enhance or request enhancement of speed or QoS for data transmissions not effected by the rules of the data saving profile.

At 318, the UE applies the rules of the data saving profile to at least one of incoming data or outgoing data. As noted herein, the applying limits some data transmissions without stopping all data transmissions.

At 320, the UE may use machine learning to build the data saving profile. Such use of machine learning may be ongoing from reception/installation of the data savings profile.

FIG. 4 is a schematic diagram of a computing device capable of implementing functionality of the UE. As shown, the computing device 400 includes a memory 402 storing modules and data 404, processor(s) 406, transceivers 408, and input/output devices 410.

In various examples, the memory 402 can include system memory, which may be volatile (such as RAM), non-volatile (such as ROM, flash memory, etc.) or some combination of the two. The memory 402 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store the desired information.

The memory 402 can include one or more software or firmware elements, such as computer-readable instructions that are executable by the one or more processors 406. For example, the memory 402 can store computer-executable instructions associated with modules and data 404. The modules and data 404 can include a platform, operating system, and applications, and data utilized by the platform, operating system, and applications. Further, the modules and data 404 can implement any of the functionality for the UE 102 or any other node/device described and illustrated herein.

In various examples, the processor(s) 406 can be a central processing unit (CPU), a graphics processing unit (GPU), or both CPU and GPU, or any other type of processing unit. Each of the one or more processor(s) 406 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 406 may also be responsible for executing all computer applications stored in the memory 402, which can be associated with types of volatile (RAM) and/or nonvolatile (ROM) memory.

The transceivers 408 can include modems, interfaces, antennas, Ethernet ports, cable interface components, and/or other components that perform or assist in exchanging wireless communications, wired communications, or both.

While the computing device need not include input/output devices 410, in some implementations it may include one, some, or all of these. For example, the input/output devices 410 can include a display, such as a liquid crystal display or any other type of display. For example, the display may be a touch-sensitive display screen and can thus also act as an input device or keypad, such as for providing a soft-key keyboard, navigation buttons, or any other type of input. The input/output devices 410 can include any sort of output devices known in the art, such as a display, speakers, a vibrating mechanism, and/or a tactile feedback mechanism. Output devices can also include ports for one or more peripheral devices, such as headphones, peripheral speakers, and/or a peripheral display. The input/output devices 410 can include any sort of input devices known in the art. For example, input devices can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

Although features and/or methodological acts are described above, it is to be understood that the appended claims are not necessarily limited to those features or acts. Rather, the features and acts described above are disclosed as example forms of implementing the claims.

What is claimed is:

1. A method comprising:
determining, by a user equipment (UE), an occurrence of a triggering event associated with a data saving profile, the data saving profile including rules for at least two of stopping background data, limiting short message service (SMS) retries, early timeouts, stopping incoming calls or redirecting incoming calls to voicemail, blocking video streaming, limiting connection attempts, restricting use of the UE as a personal hotspot, or restricting use of certain access point names (APNs) or data network names (DNNs);
in response to the occurrence of the triggering event, activating, by the UE, the data saving profile; and
applying, by the UE, the rules of the data saving profile to at least one of incoming data or outgoing data, wherein the applying limits some data transmissions without stopping all data transmissions.

2. The method of claim 1, wherein the triggering event is at least one of:
receiving an instruction to activate the data saving profile from a server, base station, or access point;
connecting to a different public land mobile network (PLMN);
roaming;
moving across a geofence boundary; or
connecting to a specific APN or DNN.

3. The method of claim 2, further comprising at least one of receiving the instruction or receiving the data saving profile when the UE A) connects to a network other than its home network and 2) is subject to a reduced data quality-of-service (QoS) or to a data limit.

4. The method of claim 1, further comprising enabling a user of the UE to toggle the data saving profile on or off.

5. The method of claim 1, further comprising enhancing or requesting enhancement of speed or quality-of-service for data transmissions not effected by the rules of the data saving profile.

6. The method of claim 1, wherein multiple ones of the rules of the data saving profile are expressed as a single requirement that limits or blocks data transmissions not resulting from an action initiated by a user of the UE.

7. The method of claim 1, wherein the data saving profile is pre-installed on the UE or received from a home network of the UE.

8. The method of claim 1, wherein the data saving profile includes a suggested blacklist of websites or services and the activating comprises seeking acceptance or rejection of the suggested blacklist by a user of the UE.

9. The method of claim 1, further comprising using machine learning to build the data saving profile.

10. The method of claim 1, further comprising selecting one of multiple data saving profiles as the data saving profile, wherein the multiple data saving profiles are associated with multiple corresponding PLMNs, multiple corresponding countries or country groups, or multiple corresponding user activity profiles.

11. A user equipment (UE) comprising:
one or more processors; and
programming instructions that, when executed by the one or more processors, cause the UE to perform operations including:
determining an occurrence of a triggering event associated with a data saving profile, the data saving profile including rules for at least two of stopping background data, limiting short message service (SMS) retries, early timeouts, stopping incoming calls or redirecting incoming calls to voicemail, blocking video streaming, limiting connection attempts, restricting use of the UE as a personal hotspot, or restricting use of certain access point names (APNs) or data network names (DNNs);
in response to the occurrence of the triggering event, activating the data saving profile; and
applying the rules of the data saving profile to at least one of incoming data or outgoing data, wherein the applying limits some data transmissions without stopping all data transmissions.

12. The UE of claim 11, wherein the triggering event is at least one of:
receiving an instruction to activate the data saving profile from a server, base station, or access point;
connecting to a different public land mobile network (PLMN);
roaming;
moving across a geofence boundary; or
connecting to a specific APN or DNN.

13. The UE of claim 11, wherein multiple ones of the rules of the data saving profile are expressed as a single requirement that limits or blocks data transmissions not resulting from an action initiated by a user of the UE.

14. The UE of claim 11, wherein the data saving profile is pre-installed on the UE or received from a home network of the UE.

15. The UE of claim 11, wherein the data saving profile includes a suggested blacklist of websites or services and the activating comprises seeking acceptance or rejection of the suggested blacklist by a user of the UE.

16. The UE of claim 11, wherein the operations further include selecting one of multiple data saving profiles as the data saving profile, wherein the multiple data saving profiles are associated with multiple corresponding PLMNs, multiple corresponding countries or country groups, or multiple corresponding user activity profiles.

17. A non-transitory computer storage medium having programming instructions stored thereon that, when executed by one or more processors of a user equipment (UE), cause the UE to perform operations comprising:
determining an occurrence of a triggering event associated with a data saving profile, the data saving profile including rules for at least two of stopping background data, limiting short message service (SMS) retries, early timeouts, stopping incoming calls or redirecting incoming calls to voicemail, blocking video streaming, limiting connection attempts, restricting use of the UE as a personal hotspot, or restricting use of certain access point names (APNs) or data network names (DNNs);
in response to the occurrence of the triggering event, activating the data saving profile; and
applying the rules of the data saving profile to at least one of incoming data or outgoing data, wherein the applying limits some data transmissions without stopping all data transmissions.

18. The non-transitory computer storage medium of claim 17, wherein the triggering event is at least one of:
receiving an instruction to activate the data saving profile from a server, base station, or access point;
connecting to a different public land mobile network (PLMN);
roaming;
moving across a geofence boundary; or
connecting to a specific APN or DNN.

19. The non-transitory computer storage medium of claim 17, wherein the data saving profile is pre-installed on the UE or received from a home network of the UE.

20. The non-transitory computer storage medium of claim 17, wherein the operations further comprise selecting one of multiple data saving profiles as the data saving profile, wherein the multiple data saving profiles are associated with multiple corresponding PLMNs, multiple corresponding countries or country groups, or multiple corresponding user activity profiles.
